(19) United States
(12) Patent Application Publication
(10) Pub. No.: US 2026/0332884 A1
(43) Pub. Date: Oct. 22, 2026

(54) IMAGE CAPTURE CONTROL APPARATUS, IMAGE CAPTURE CONTROL METHOD, AND IMAGE CAPTURE SYSTEM

(71) Applicant: CANON KABUSHIKI KAISHA, Tokyo (JP)

(72) Inventors: ASUKA MATSUOKA, Kanagawa (JP); MUNEKI ANDO, Kanagawa (JP); MASASHI KOTOKU, Kanagawa (JP); MASARU KUROTA, Tokyo (JP)

(21) Appl. No.: 19/629,761

(22) Filed: Mar. 26, 2026

(30) Foreign Application Priority Data
Apr. 18, 2025 (JP) 2025-069084

(51) Int. Cl. H04N 23/60; H04N 23/66; H04N 23/69; H04N 23/695

(52) U.S. Cl. CPC H04N 23/64; H04N 23/66; H04N 23/69; H04N 23/695

(57) ABSTRACT

Disclosed is an image capture control apparatus acquires first video capturing an entirety of a predetermined capture range and provides the first video and text information to a generative AI model. The text information describes a content of processing to be executed based on the first video, information to be output as a result of the processing, a method of outputting the information, and a precondition of the processing. The apparatus acquires, from the generative AI model, information that is based on the text information and determines a role for each of one or more remotely controllable image capture apparatuses, based on the acquired information. Base on the determined role, the apparatus controls one or both of a capture direction and an angle of view of each of the one or more image capture apparatuses.

### BACKGROUND

### Field of the Technology

The present disclosure relates to an image capture control apparatus, an image capture control method, and an image capture system, and particularly to a technique for controlling a plurality of image capture apparatuses.

### Description of the Related Art

Japanese Patent Application Laid-Open No. 2025-38771 describes an image capture system that prepares control contents that correspond to a main object of a main camera and operation of the main camera as a role and automatically controls a capture direction and an angle of view of a sub-camera according to a role assigned to the sub-camera.

In this image capture system, operations performed on the sub-camera are automated, thus enabling significant labor savings to be realized. Also, the control contents of the sub-camera can be flexibly changed, by switching the role assigned to the sub-camera. However, the switching of roles needs to be implemented manually by an operator, and thus there is room for improvement in terms of labor savings.

### SUMMARY

At least one of embodiments according to the present disclosure realizes an improvement in the usability of an image capture control apparatus that automatically controls a capture operation of a camera.

According to an aspect of the present disclosure, there is provided an image capture control apparatus, comprising one or more processors that execute a program stored in a memory and thereby cause the image capture control apparatus to: acquire first video capturing an entirety of a predetermined capture range; provide the first video and text information to a generative AI model, the text information describing a content of processing to be executed based on the first video, information to be output as a result of the processing, a method of outputting the information, and a precondition of the processing, and acquire, from the generative AI model, information that is based on the text information; determine a role for each of one or more remotely controllable image capture apparatuses, based on the information acquired from the generative AI model; and control one or both of a capture direction and an angle of view of each of the one or more image capture apparatuses, in accordance with the determined role.

Features of the present disclosure will become apparent from the following description of embodiments with reference to the attached drawings. The following description of embodiments is given by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a schematic diagram of an image capture system according to an embodiment.

FIG. 2 is a block diagram showing an example functional configuration of apparatuses of the image capture system according to the embodiment.

FIG. 3 is a diagram showing an image capture control apparatus according to a first embodiment, focusing on principal operations and signal flow.

FIGS. 4A to 4C are flowcharts relating to operations of the apparatuses of the image capture system according to the embodiment.

FIG. 5 is the flowchart relating to role determination processing in the embodiment.

FIGS. 6A and 6B are diagrams for describing coordinate transformation in the embodiment.

FIGS. 7A and 7B are diagrams relating to object detection and coordinate transformation in the embodiment.

FIG. 8 is a diagram for describing pan value calculation in the embodiment.

FIG. 9 is a diagram for describing tilt value calculation in the embodiment.

FIG. 10 is a diagram showing an image capture control apparatus according to a second embodiment, focusing on principal operations and signal flow.

FIG. 11 is a diagram showing the image capture control apparatus according to the second embodiment, focusing on principal operations and signal flow.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

### Overview of the Multi-Camera Image Capture System

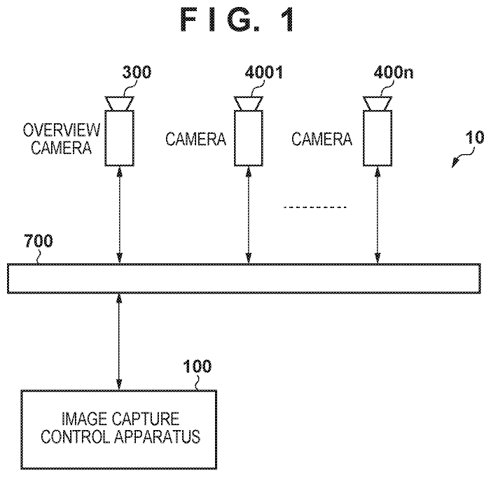

FIG. 1 is a schematic diagram showing an example configuration of a multi-camera image capture system 10 (hereinafter, simply “image capture system”) according to the present embodiment. The image capture system 10 has a plurality of cameras 300 and 4001 to 400n, an image capture control apparatus 100, and a role control apparatus 600. The cameras 300 and 4001 to 400n (where n is an integer not less than 2), the image capture control apparatus 100, and the role control apparatus 600 are connected to each other in a communicable manner through a communication network 700.

The communication network 700 complies with a known wired or wireless communication standard such as the IEEE 802.3 series or the IEEE 802.11 series. Also, the cameras 300 and 4001 to 400n, the image capture control apparatus 100, and the role control apparatus 600 each have a communication interface that complies with the standards of the communication network 700.

Of the cameras (image capture apparatuses) 300 and 4001 to 400n, the camera 300 outputs video (first video) that captures the entirety of a predetermined capture range. The capture range is set as, for example, a range in which an object targeted for image capture can be present in a studio or, in the case of sports that use a court, as a range that includes the entire court. Accordingly, video from the camera 300 captures all objects that are present within the capture range.

The purpose of providing the camera 300 is to capture video for detecting an object targeted for image capture that is present within the capture range. Accordingly, the capture direction and angle of view of the camera 300 are determined according to the position and capture range of the camera 300, and the capture direction and the angle of view are essentially fixed during image capture. Furthermore, the aperture value and focusing distance of the camera 300 may also be fixed values determined such that a pan focus image is obtained, for example. Also, the camera 300 preferably captures the entirety of the capture range so as to not be obscured by objects outside the capture range. Thus, herein, the camera 300 is provided at a position overviewing the entire capture range. In order to distinguish from the other cameras 4001 to 400n whose capture direction and angle of view are essentially not fixed during image capture, the camera 300 will hereinafter be referred to as an overview camera. The installation position of the camera 300 is, however, not limited to a position overviewing the capture range. The operations of the overview camera 300 are remotely controllable from the image capture control apparatus 100.

The cameras 4001 to 400n are n number of cameras (where n is an integer not less than 2). Hereinafter, in description common to the cameras 4001 to 400n, the cameras 4001 to 400n will be collectively referred to as “camera 400”.

The camera 400 is a Pan-Tilt-Zoom (PTZ) camera, for example, and operations thereof including capture direction (pan and tilt angles) and angle of view (zoom) can be remotely controlled from the image capture control apparatus 100. Note that the installation position (viewpoint position) of the cameras 300 and 400 of the image capture system 10 is assumed to be fixed.

The following information regarding the cameras 300 and 400 is assumed to be stored in a ROM 103 in advance and to be known to the image capture system 10: camera type (whether overview camera or not), name or identification information, coordinate values of installation position (viewpoint position) and coordinate values of origin, reference capture direction, controllable range of pan and tilt angles relative to reference capture direction, and controllable range of zoom (angle of view). Note that, if marks are installed in the capture range, the positions of the marks are assumed to be stored in advance in the ROM 103.

The position may be, for example, three-dimensional (3D) coordinates obtained by a Global Positioning Satellite System (GNSS) or 3D coordinates whose origin is one point within the capture range. In the case of 3D coordinates whose origin is one point within the capture range, information of the coordinates of the origin is also assumed to be known together with the camera position. The reference capture direction may be, for example, the pan angle and tilt angle when the initial values of the pan angle and tilt angle of the drive unit 409 are 0 degrees.

Herein, the image capture control apparatus 100 is assumed to control the operations of the cameras 4001 to 400n. Note that one of the cameras 4001 to 400n may be taken as a main camera and the remaining cameras may be taken as sub-cameras, and the operations of the sub-cameras may be controlled based on one or more of the video, capture direction, and angle of view of the main camera. In this case, the user of the image capture system may control the operations of the main camera.

Herein, in the present embodiment, the image capture control apparatus 100 is assumed to have an operator. The image capture control apparatus 100 controls image capture by the overview camera 300 and the camera 400, and thus the cameras 300 and 400 do not require a camera operator.

Note that, in FIG. 1, all signals are shown as being communicated by the communication network 700, but video signals and control signals, for example, may be communicated by different methods. The cameras 300 and 4001 to 400n may, for example, supply video signals directly to the image capture control apparatus 100 by cable. The cameras 300 and 4001 to 400n and the image capture control apparatus 100 may, for example, have communication circuits that correspond to the standards of the video signals. Video signal standards include, for example, Serial Digital Interface (SDI), High-Definition Multimedia Interface (HDMI) (registered trademark), and the like.

The image capture control apparatus 100 performs object detection on the video signal received from the overview camera 300. The image capture control apparatus 100 determines the role to be assigned to each of the cameras 4001 to 400n based on the result of the object detection and the output of a generative AI model. The image capture control apparatus 100 then determines at least one of the capture direction and angle of view of the cameras 4001 to 400n to satisfy rules that are based on the determined role. The image capture control apparatus 100 transmits control commands that include the determined capture direction and/or angle of view to each of the cameras 4001 to 400n. By changing the role assigned to each of the cameras 4001 to 400n, the capture direction and/or angle of view determination method can be changed on a camera by camera basis, and automatic control of the cameras 4001 to 400n with a high degree of freedom can be realized. By continuously implementing automatic control, the cameras 4001 to 400n track and capture images of specific objects that correspond to their respective role (while maintaining a designated specific composition if designated by the role).

### Example Functional Configuration of Apparatuses

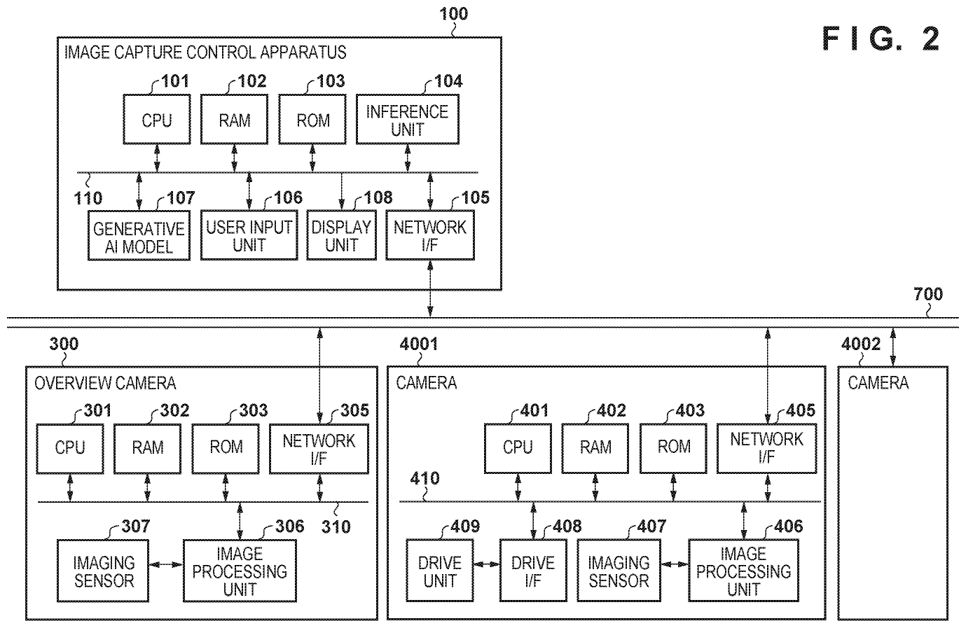

FIG. 2 is a block diagram showing an example functional configuration of the devices constituting the multi-camera image capture system 10 shown in FIG. 1. Herein, the case where the n number of cameras 400 in FIG. 1 is 2 is shown, but n may be 3 or more. Note that configurations represented as functional blocks in the diagrams can be realized by an integrated circuit such as an ASIC or a FPGA, by a discrete circuit, or by combining a memory with a processor that executes programs stored in the memory. Also, one functional block may be realized by a plurality of integrated circuit packages, or a plurality of functional blocks may be realized by one integrated circuit package. Also, the same functional block may be implemented in different configurations according to the operational environment, required capabilities, and the like.

### Image Capture Control Apparatus 100

First, an example functional configuration of the image capture control apparatus 100 will be described. The image capture control apparatus 100 may be a general-purpose computer device, such as a personal computer or a workstation, for example. The image capture control apparatus 100 has a configuration in which a CPU 101, a RAM 102, a ROM 103, an object detection unit 104, a network interface (I/F) 105, a user input unit 106, and a display unit 108 are connected to each other via an internal bus 110.

The CPU 101 is a microprocessor capable of executing programmed instructions. The CPU 101 realizes the functions of the image capture control apparatus 100 described later, by loading programs stored in the ROM 103 to the RAM 102 and executing the loaded programs. The CPU 101 is able to realize the functions of the image capture control apparatus 100, by executing an image capture control application that runs on an Operating System (OS), for example.

The RAM 102 is used in order to load programs to be executed by the CPU 101, and to temporarily store data for processing by the CPU 101, data that is being processed, and the like. Also, part of the RAM 102 may be used as a video memory for the display unit 108.

The ROM 103 is a rewritable, non-volatile memory and stores programs (OS and applications) to be executed by the CPU 101, user data, and the like.

The object detection unit 104 executes processing for detecting an object area using a machine learning model on video from the overview camera 300. The object detection unit 104 can be implemented using a hardware circuit capable of executing computations of a machine learning model at high speed. Such a hardware circuit is, for example, a Graphics Processing Unit (GPU), an NPU (Neural Network Processing Unit), or the like. Alternatively, the object detection unit 104 may be implemented using a reconfigurable logic circuit such as a Field-Programmable Gate Array (FPGA). The CPU 101 may realize the functions of the object detection unit 104 by executing programs.

The machine learning model may be a Convolutional Neural Network (CNN) trained according to the type of object to be detected. Herein, the object detection unit 104 is assumed to detect a body area or a face area of a person as the object area from an input image. The object detection unit 104 also detects, as an object area, equipment and places that are used in sports, such as balls (moving objects handled by players such as shuttlecocks, pucks, etc.), rackets (implements held by players), nets, goals, courts, grounds, fields, and the like. Also, the object detection unit 104 is assumed to output, for every detected object area, the position and size of a rectangular area that circumscribes the object area and a detection reliability. Note that processing for detecting different types of object areas may be executed on the same input image using different types of machine learning models. Note that the object detection unit 104 may implement the object area detection processing by a known method that does not use a machine learning model. The object detection unit 104 is able to detect object areas using a method that uses local feature values such as SIFT or SURF, or a method that uses pattern matching, for example.

The network I/F 105 is an interface for connecting the image capture control apparatus 100 to the communication network 700. The image capture control apparatus 100 (CPU 101) is able to communicate with external devices over the communication network 700, such as the overview camera 300 and the cameras 4001 and 4002, through the network I/F 105. Note that the image capture control apparatus 100 may communicate with external devices through other communication interfaces (USB, Bluetooth (registered trademark), etc.) that are not shown.

The CPU 101, in order to communicate with the apparatuses (overview camera 300, cameras 4001 and 4002) over the communication network 700, acquires network addresses of the apparatuses at any time and stores the acquired network addresses in the RAM 102. The CPU 101 also acquires information about the apparatuses (apparatus type, model name, etc.) at any time (e.g., at time of initial communication) and stores the acquired information in the RAM 102. In this way, the CPU 101 is assumed to know at least the identification information and apparatus type of the overview camera 300 and the cameras 4001 and 4002. Note that a configuration may also be adopted in which the user is able to freely name the individual apparatuses.

The user input unit 106 is an input device such as a mouse, a keyboard, a touch panel, or the like. The image capture control apparatus 100 receives commands from the user through the user input unit 106.

The display unit 108 is a display device such as a liquid crystal display (LCD). The display unit 108 displays GUI screens that are provided by the operating system, the image capture control application, and the like.

A generative AI model 107 generates and outputs information designated by information provided in text from the CPU 101, based on video from the overview camera 300. Note that, in the present disclosure, a “generative AI model” is a model that uses a trained large-scale machine learning model to realize AI capable of generating content such as documents, images, programs, and the like in accordance with conditions and commands included in text information called prompts. The generative AI model 107 is similar to the object detection unit 104 in terms of using a machine learning model but differs in being capable of generating various output according to the contents of the text information.

The generative AI model 107 can be implemented using a hardware circuit capable of executing computations of a machine learning model at high speed, such as a GPU or an NPU. Note that a generative AI model may be implemented using an SoC, which integrates a CPU, a GPU, and a NPU onto a single chip and is used in smartphones and the like in recent years. In this case, at least one of the object detection unit 104 and the generative AI model 107 can be integrated into the CPU 101.

Note that the generative AI model 107 may be provided in a device other than the image capture control apparatus 100. Given that video from the overview camera 300 is used, the generative AI model 107 may be installed in the overview camera 300. Also, a computer device for mainly executing the generative AI model 107 may be separately provided on the communication network 700. Alternatively, the generative AI model 107 may be provided in a server on an external network (e.g., cloud) accessible through the communication network 700. That is, the generative AI model 107 need only be utilizable from the image capture system 10 and need not be part of the image capture system 10.

Also, the image capture system 10 may cause the generative AI model 107 to implement object detection similar to the object detection unit 104. In this case, the object detection unit 104 is not required.

In the present embodiment, the image capture control apparatus 100 automatically controls at least one of the capture direction and angle of view of the cameras 4001 and 4002. Also, the image capture control apparatus 100 determines the “role” assigned for every camera. The “role” is information describing what control is to be implemented (control contents) with regard to one or more control items relating to the camera 400. The image capture control apparatus 100 controls the operations of the individual cameras, in accordance with the control contents described in the “role” assigned to each of the cameras 4001 and 4002. The roles and control operations will be described in detail later.

In the present embodiment, labor savings relating to assignment of roles to the cameras is realized utilizing the generative AI model 107 in determining and changing the roles assigned to each of the cameras 4001 and 4002. Note that, in the present disclosure, a “generative AI model” is a model that uses a trained large-scale machine learning model to realize AI capable of generating content such as documents, images, and programs in accordance with conditions and commands included in text information called prompts.

In the present embodiment, information necessary for determining roles is acquired from the generative AI model 107, by inputting video acquired from the overview camera 300 and text information including prompts into the multimodal generative AI model 107 which is capable of receiving input of text information and images. The generative AI model 107 is implementable using any known multimodal AI model capable of receiving input of text information and images, such as ChatGPT by OpenAI, Gemini by Google, and Llama by Meta. Examples of specific methods of utilizing the generative AI model 107 will be described later.

### Overview Camera 300

Next, an example functional configuration of the overview camera 300 will be described.

The CPU 301 is a microprocessor capable of executing programmed instructions. The CPU 301 controls the operations of the functional blocks and realizes the functions of the overview camera 300 described later, by loading programs stored in the ROM 303 into the RAM 302 and executing the loaded programs, for example.

The RAM 302 is used in order to load programs to be executed by the CPU 301, and to temporarily store data for processing by the CPU 301, data that is being processed, and the like. Also, the RAM 302 may be used as a buffer for video signals obtained by image capture.

The ROM 303 is a rewritable non-volatile memory. The ROM 303 stores programs to be executed by the CPU 301, setting values of the overview camera 300, user data, and the like. Note that the ROM 303 can also be used as a recording destination for video signals. The ROM 303 may include an internal memory and a removable memory card.

An imaging sensor 307 has an image capture optical system and an image sensor. The image sensor may be a known CCD or CMOS color image sensor having a primary Bayer array color filter, for example. The image sensor has a pixel array in which pixels are arrayed two dimensionally and a peripheral circuit for reading out signals from the pixels. The pixels accumulate electric charge that corresponds to the amount of incident light through photoelectric conversion. By reading out a signal having a voltage that corresponds to the amount of charge accumulated during an exposure period from each pixel and A/D converting the signals, a group of pixel signals (digital image signals) representing an object image formed on an image capture surface is obtained.

The image processing unit 306 applies predetermined signal processing and image processing to the digital image signals output by the imaging sensor 307 to generate signals and image data that correspond to the use application, and to acquire and/or generate various types of information.

The processing applied by the image processing unit 306 can include, for example, preprocessing, color interpolation processing, correction processing, detection processing, data processing, evaluation value calculation processing, special effects processing, and the like.

Preprocessing can include digital signal amplification, reference level adjustment, defective pixel correction, and the like. Note that a configuration may be adopted in which preprocessing is performed inside the image sensor.

Color interpolation processing is performed in the case where the imaging sensor 307 is provided with a color filter and is processing for interpolating the values of color components that are not included in the individual pixel data constituting image data. Color interpolation processing is also called demosaic processing.

Correction processing can include processing such as white balance adjustment, gradation correction, correction of image degradation caused by optical aberration of the image capture optical system (image recovery), correction of the effects of peripheral dimming of the image capture optical system, color correction, and the like.

Data processing can include processing such as trimming of areas (cropping), composition, scaling, encoding/decoding, header information generation (data file generation), and the like. Data processing also includes generation of video signals to be output externally and video data to be recorded on the ROM 303.

Evaluation value calculation processing can include processing such as generation of signals and evaluation values for use in auto-focus detection (AF) and generation of evaluation values for use in auto-exposure control (AE). AF and AE are executed by the CPU 301.

Special effects processing can include addition of bokeh, changing color tone, relighting, and the like.

Note that the above are illustrative examples of processing applicable by the image processing unit 306, and do not limit the processing that is applied by the image processing unit 306.

The image processing unit 306 outputs acquired or generated information and data to the CPU 301, the RAM 302, and the like according to the use application.

Note that the type and setting of processing applied by the image processing unit 306 can be controlled by the image capture control apparatus 100 transmitting commands to the overview camera 300.

The network I/F 305 is an interface for connecting the overview camera 300 to the communication network 700. The overview camera 300 (CPU 301) is able to communicate through the network I/F 305 with the image capture control apparatus 100 and the cameras 4001 and 4002 and with other external devices that can communicate through the communication network 700. Note that the overview camera 300 may communicate with external devices through other communication interfaces (USB, Bluetooth, etc.) that are not shown.

### Camera 400

Next, an example functional configuration of cameras 4001 and 4002 will be described. The functional configuration of the cameras 4001 and 4002 may be the same as each other and thus will be described below as the configuration of the camera 400. Also, functional blocks with the same name as those of the overview camera 300 are assumed to have the same function, and description thereof will be omitted.

As mentioned above, the camera 400 is a PTZ camera, and the capture direction and the angle of view can be controlled externally. Thus, the camera 400 has a drive unit 409 capable of pan and tilt operations and a zoom operation, and a drive I/F 408. The drive I/F 408 is a communication interface between the drive unit 409 and a CPU 401.

The drive unit 409 has a pan/tilt mechanism that supports the camera 400 in a pannable and tiltable manner, a zoom mechanism that changes the angle of view of the image capture optical system, a motor that drives these mechanisms, and the like. The zoom mechanism may use processing for enlarging and reducing digital images by the image processing unit 406. The drive unit 409 drives the motor in accordance with commands received from the CPU 401 through the drive I/F 408 and adjusts the optical axis direction and angle of view of the image capture optical system.

### Roles

In the present embodiment, the image capture control apparatus 100 automatically controls at least one of the capture direction and angle of view of the cameras 4001 and 4002. Also, the image capture control apparatus 100 automatically controls the operations of the cameras 4001 and 4002 in accordance with control contents described in the “role” assigned to each camera.

A “role” is information that includes one or more of a plurality of control items (e.g., main object, composition, angle of view), and in which control contents are described for every control item. Different roles can not only have different combinations of control items but also different control contents for the same control item. In the case of different roles, the combinations of control items or one or more of the control contents of every control item are different.

Data describing a role can have the following configuration, for example:
{Identification Information}, {Control Item 1, Control Contents 1}, {Control Item 2, Control Contents 2}, . . . , {Control Item n, Control Contents n}
   n is an integer not less than 3. Note that a configuration may be adopted in which there are no more than two control items. The identification information may be a unique name, number, or the like.

The control contents that can be described differ for every control item. In relation to the control item “main object”, for example, control contents such as the following can be described:
All (all specific objects present in the capture range)·
Specific group (specific part of specific object present in the capture range)

Examples include a specific team in a team sport, a plurality of people in a specific position in an artist group, and the like.
Specific one (specific one of specific object present in the capture range)

Examples include a specific player in a team sport, a specific person within a group, a ball or a shuttlecock for use in competition, and the like. Also, it is possible to designate an object that is a specified number of people from the far right or far left.

Also, in relation to the control item “composition”, control contents such as the following can be described.
Size of main object

Examples include the size at which the entirety of the main object is captured, upper body, bust shot, closeup of the face, and the like.
Position of main object

Examples include the position of the main object within the image (center, right side, left side, etc.), widening the direction in which the main object is facing, and the like.

Also, in relation to the control item “angle of view”, control contents such as the following can be described.
Upper limit or lower limit

Examples include designating the maximum and/or minimum angle of view, and the like.

Note that control contents based on information of one specific camera (“main camera”), out of the cameras 4001 and 4002, can also be designated.

For example, in relation to the control item “main object”:
Possible designations include: same player/team as the main object of the main camera; different player/team from the main object of the main camera; object that is the nth person from the right or left based on the main object of the main camera.

Also, in relation to the control item “composition”:
Possible designations include: make larger (or smaller) than the main object of the main camera; same position as (or different position from) the main object of the main camera.

Also, in relation to the control item “angle of view”:
Possible designations include: synchronize movement in the same direction as or opposite direction to zoom operation of the main camera or do not synchronize movement.

The control items and control contents enumerated here are merely illustrative examples, and other control items and control contents may be included.

In the case where roles that can be set for the cameras 4001 and 4002 are prepared in advance, data describing the roles can be stored in the ROM 103 in table format, for example. By operating a setting screen displayed on the display unit 108 with the user input unit 106, the user is able to delete roles stored in the ROM 103, to change control items and control contents, and to add new roles.

### Description of Operations of Apparatuses

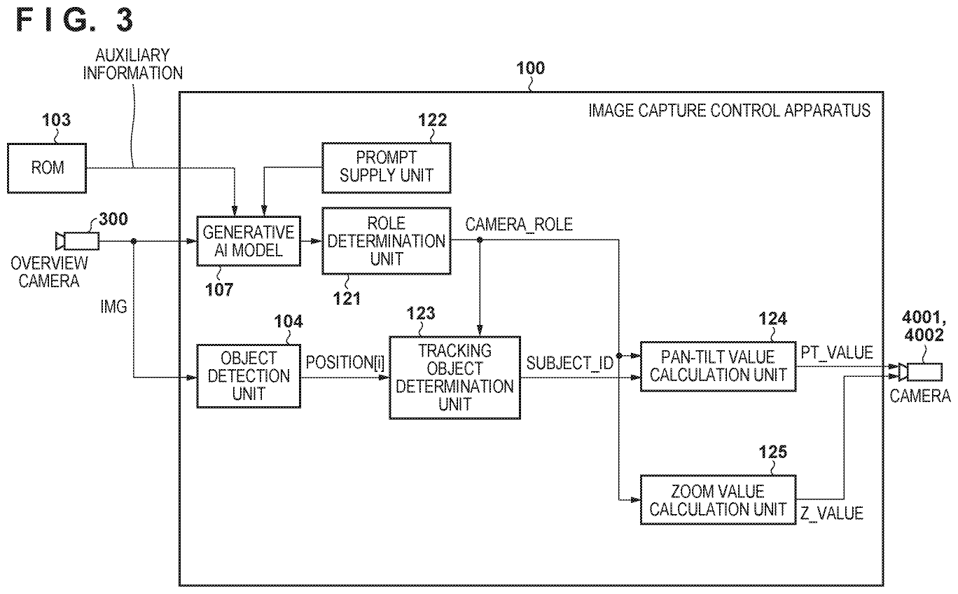

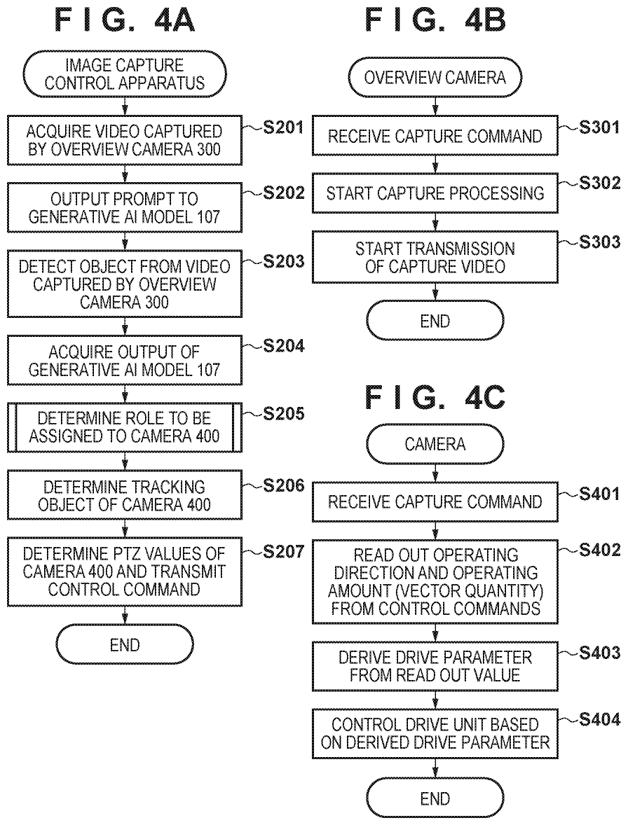

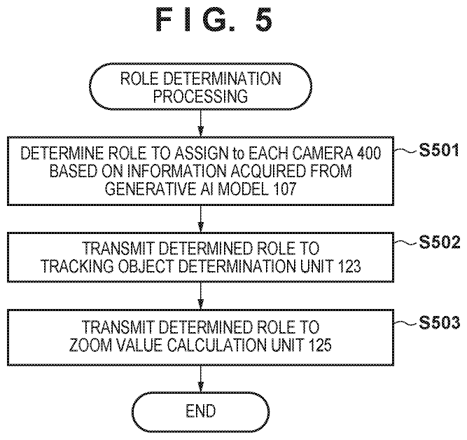

Next, operations of the apparatuses in the image capture system 10 will now be described with further reference to FIGS. 3 to 5. FIG. 3 is a diagram showing a series of processing that is implemented by the image capture control apparatus 100 when controlling the operations of the camera 400, focusing on the principal operations and signal flow. FIGS. 4A to 4C are flowcharts respectively relating to operations of the image capture control apparatus 100, the overview camera 300, and the camera 400. Also, FIG. 5 is a flowchart showing the operations of the CPU 101 serving as a role determination unit 121 shown in FIG. 3.

Note that the functional blocks 121 to 125 shown within the image capture control apparatus 100 in FIG. 3 schematically show the principal functions that are realized by the CPU 101 executing the image capture control application. The image capture control apparatus 100 determines the roles to be assigned to the cameras 4001 and 4002 based on video from the overview camera 300 and information obtained from the generative AI model 107 and automatically controls the capture operation of the cameras based on the determined roles.

### Operations of Image Capture Control Apparatus 100

First, operations of the image capture control apparatus 100 for controlling image capture by the camera 400 will be described with reference to FIGS. 3 and 4A.

In step S201, the CPU 101 serving as video acquisition means transmits a capture command to the overview camera 300, through the network I/F 105, using a predetermined protocol. In response to this command, the overview camera 300 starts supplying a video signal (moving image data) IMG to the network I/F 105. The CPU 101 starts storing the video signal received through the network I/F 105 in the RAM 102 and thereafter executes step S202.

The CPU 101 (prompt supply unit 122) serving as information acquisition means in step S202 outputs a prompt to the generative AI model 107. Also, the CPU 101 reads out moving image data IMG from the RAM 102 and supplies the read out moving image data IMG to the generative AI model 107 and the object detection unit 104. Note that in the case where the generative AI model 107 does not support unfiled moving image data, the CPU 101 may decompose the video data into frame images and supply a data file of the frame images to the generative AI model 107. Moving image data IMG is continuously supplied to the generative AI model 107 and the object detection unit 104 until a predetermined termination condition is satisfied. A prompt is text information that describes the contents of processing for supplying moving image data IMG to the generative AI model 107, preconditions, the output format of processing results, and the like in a document written in natural language.

In the present embodiment, the generative AI model 107 is used for the purpose of acquiring information for the image capture control apparatus 100 to automatically determine the role to be assigned to the camera 400, based on video captured by the overview camera 300.

Specifically, the generative AI model 107 is utilized as follows:

Example 1: The generative AI model is used to determine the capture scene.

Example 2: The generative AI model is used to determine which candidate to assign to each camera from candidates for roles assignable to the camera 400.

Example 3: The generative AI model is used to generate a role to be assigned to each camera from candidates for control contents prepared for every control item.

Note that these are merely illustrative examples and are not intended to limit the methods of utilizing the generative AI model 107. The generative AI model 107 may be used in order to acquire other information for automatically determining the role to be assigned to the camera 400.

Accordingly, the prompt supply unit 122 outputs prompts whose contents differ for each of the utilization methods shown in Examples 1 to 3 to the generative AI model 107. Which of Examples 1 to 3 to implement is assumed to have been set in advance by a setting operation performed through the user input unit 106. Alternatively, the CPU 101 can automatically select one of Examples 1 to 3 in accordance with some other condition. To give an example, the processing load increases from Example 1 to Example 3, and thus the CPU 101 is able to select Example 2 or Example 3 in the case where the generative AI model 107 resides on a cloud, and to select Example 1 in the case where the generative AI model 107 resides within the image capture system 10. With regard to selecting between Examples 2 and 3, the CPU 101 is, for example, able to select Example 3 if the communication speed of communication with an external device in which the generative AI model 107 resides is greater than or equal to a threshold, and to select Example 2 if the communication speed is less than the threshold.

Prompts respectively corresponding to Examples 1 to 3 can be generated in advance using a prompt creation assistant tool or the like, for example, and stored in the ROM 103, for example. The CPU 101 reads out an appropriate prompt from the ROM 103, according to which of Example 1 to Example 3 is to be implemented, and outputs the read out prompt to the generative AI model 107. Note that the output format of prompts can differ according to the generative AI model 107 that is used.

While the method of describing prompts is not particularly restricted, it is desirable to clearly describe the preconditions, processing contents, and output format.

For example, prompts in the case of Example 1 are as follows:
Preconditions
   information (file format, etc.) of video data targeted for processing
   information of viewpoint position, capture direction, and angle of view of the overview camera 300 that captured the video data
Processing contents
   discrimination of the scene being captured from video data
   in the case of a scene of a sport that is played on a specific field such as a court, discrimination also of the orientation of the court
   cycle for implementing discrimination (e.g., how many frames between implementation)
Output format
   designation of data structure and file type
   output conditions (e.g., output when the discrimination result changes; output every time detection is performed; etc.); etc.

These may be described with a natural language document.

Note that, in the case where candidates for a capture scene are known in advance, the preconditions need only describe candidates for the type of scene, and the processing contents need only designate discrimination of the capture scene from among the scene candidates. Also, the resolution of the capture scene to be discriminated can be set with a prompt. Specifically, the type of sport may be discriminated as the type of capture scene (coarse granularity). Alternatively, the type of sport may be specified with a prompt and the kind of scene in the specified sport (e.g., whether a serve scene, an in-play scene, an out-of-play scene, or a time-out scene) may then be discriminated (fine granularity). Also, prompts in the case of Example 2 are as follows:
Preconditions
   information (file format, etc.) of video data targeted for processing
   information of viewpoint position, capture direction, and angle of view of the overview camera 300 that captured the video data
   information (name or identification information, coordinate values of installation position (viewpoint position) and coordinate values of origin, reference capture direction, controllable range of pan and tilt angles relative to the reference capture direction, controllable range of zoom (angle of view), etc.) of each of the cameras 400 assigned a role
   information (name or identification information, control item, control contents) of each of candidates for roles assignable to the cameras 400
Processing contents
   standpoint of video producer
   in the case of recognizing a capture scene from video data and capturing multi-angle video with a plurality of cameras in order to produce video of the recognized scene, selection of a suitable role from among the candidates as automatic capture control of the individual cameras
   conditions for reselection (e.g., every certain time period if the capture scene changes; etc.)
Output format
   designation of data structure and file type
   output conditions (e.g., output when the selection result changes; output every time selection is performed; etc.); etc.

These may be described with a natural language document.

Also, prompts in the case of Example 3 are as follows:
Preconditions
   information of video data targeted for processing (file format, etc.)
   information of viewpoint position, capture direction, and angle of view of the overview camera 300 that captured the video data
   information (name or identification information, coordinate values of installation position (viewpoint position) and coordinate values of origin, reference capture direction, controllable range of pan and tilt angles relative to the reference capture direction, controllable range of zoom (angle of view), etc.) of each of the cameras 400 assigned a role
   information of control items and control contents that can constitute roles assignable to the cameras 400
Processing contents
   standpoint of video producer
   in the case of recognizing a capture scene from video data and capturing multi-angle video with a plurality of cameras in order to produce video of the recognized scene, generation of suitable role by combining one or more control items and control content candidates as automatic capture control of the individual cameras
   conditions for reselection (e.g., every certain time period if the capture scene changes; etc.)
Output format
   designation of data structure and file type
   output conditions (e.g., output when the determination result changes; output every time detection is performed, etc.); etc.

These may be described with a natural language document.

Note that the output format need only be designated according to a data format interpretable by the role determination unit 121. Also, since the output contents of the generative AI model change depending on the way in which prompts are written, the description of prompts is adjusted in advance using test video and the like, and prompts that are confirmed to obtain a desired output are stored in the ROM 103.

Note that among the preconditions in the prompts of Examples 1 to 3, static information (e.g., information of overview camera 300 and camera 400) that is common to a plurality of prompts may be included in a separate text file instead of being directly included in the prompts. In this case, description (file name or URL and description of contents of the file, etc.) referring to the separate file is included in the prompts. In this way, text information that is provided to the generative AI model separately to the prompts is called auxiliary information. Auxiliary information can be written in a known format, such as JSON (JavaScript Object Notation) format or a markup language like XML. Auxiliary information can be stored in the ROM 103 in advance in text file format. Returning to FIG. 4A, in step S203, the object detection unit 104:
(1) applies object area detection processing to frame images of moving image data IMG that is input and stores the detection results;
(2) executes coordinate transformation of position information (image coordinates) for every detected object area;
(3) applies identification processing for every detected object area and specifies identification information (adds information for identification processing in the case of new objects); and
(4) stores identification information ID[n] and position information POSITION[n] in association with each other for every detected object area.

Hereinafter, the operations of the object detection unit 104 will be described in order.

(1) First, the object detection unit 104 inputs a frame image into the machine learning model and detects object areas. The object detection unit 104 stores the position and size of every detected object area output by the machine learning model as a detection result and the detection reliability in the RAM 102. The position and size of an object area may be any information capable of specifying the position and size of a rectangular area that circumscribes the object area. Herein, the central coordinates of the lower edge of the rectangular area and the width and height thereof are used as the position and size of the object area.

Also, the object detection unit 104 stores the detection result for a first frame image in the RAM 102 in association with the identification information ID[n] of the object. Herein, n is the number of the object and is an integer that takes a value between 1 and the total number of detected object areas. Furthermore, the object detection unit 104 stores an object area detected from the first frame image in the RAM 102 in association with identification information ID[n] of the object, as a template for identifying individual objects. If template matching is not used in identifying objects, templates need not be stored.

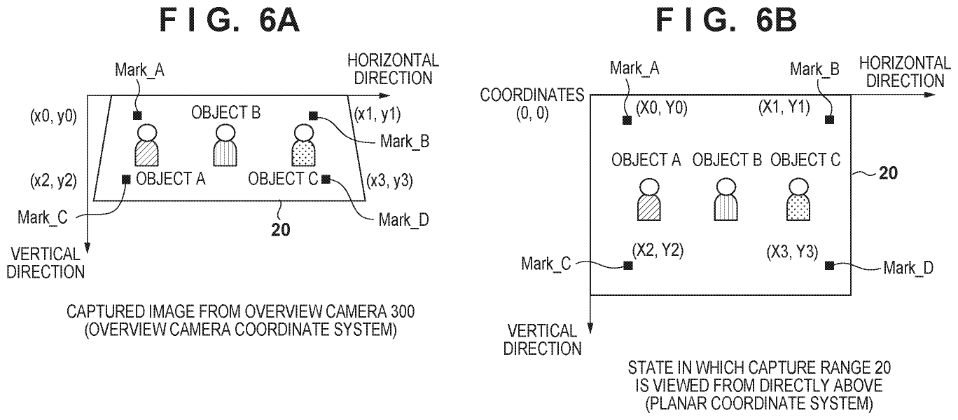

FIG. 6A is a diagram schematically depicting a capture range 20 extracted from video acquired from the overview camera 300. Herein, a scene in which three human objects A to C are present on a rectangular stage within a studio is captured, with the stage being the capture range 20.

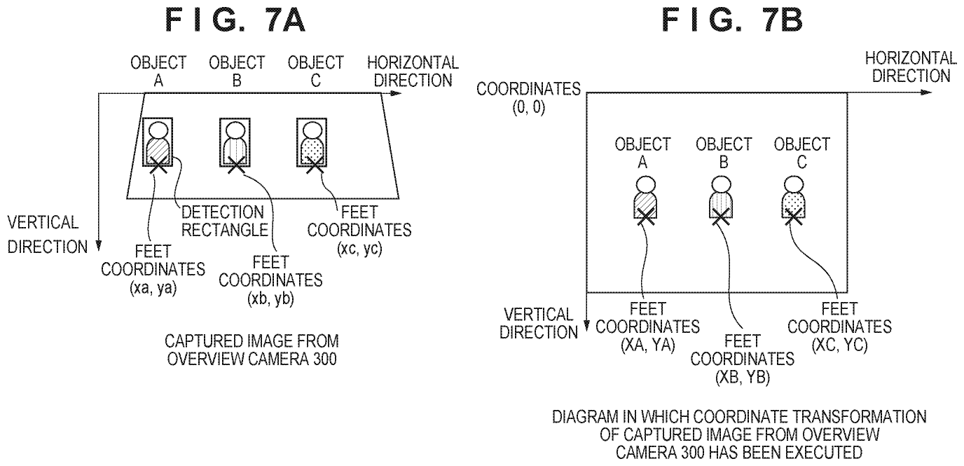

FIG. 7A shows an example of the result of object detection processing by the object detection unit 104 on video (frame images) from the overview camera 300 shown in FIG. 6A. Herein, the areas of the human objects A to C present within the capture range 20 are detected, and the coordinates of the center of the lower edge of the rectangular areas that circumscribe the object areas (coordinates at feet) are output as the positions.

Note that, in the case where marks are disposed at known positions within the capture range 20 as shown in FIG. 6B, for example, for the purposes of coordinate transformation described below, the CPU 101 detects images of the marks included in the frame image (FIG. 6A) and stores the positions in the RAM 102. Detection of mark images may also be executed by the object detection unit 104. Detection of mark images can be implemented by any known method, such as pattern matching using a template of the marks. Mark images may also be detected using a machine learning model for mark detection stored in advance.

(2) Next, coordinate transformation that is executed by the object detection unit 104 will be described. FIG. 6B schematically shows the capture range 20 in the state shown in FIG. 6A when viewed from directly above the center thereof. The object detection unit 104 executes coordinate transformation of the position of the object area in the coordinate system of the overview camera 300 to a value of a coordinate system (planar coordinate system) when the capture range 20 is viewed from directly above the center thereof.

Herein, coordinate transformation to a value in a planar coordinate system is convenient in terms of calculating a pan value (angle of movement within a horizontal plane) for allowing the camera 400 to capture an image of a specific object. Note that, herein, it is assumed that the camera 400 is installed so that the drive unit 409 pans within a horizontal plane parallel to the floor of the capture range 20.

While coordinate transformation can be executed by various methods, herein, a mark is disposed at a plurality of known positions on the floor of the capture range 20 and coordinate transformation from the overview camera coordinate system to the planar coordinate system is executed, based on the mark positions in the video obtained by the overview camera 300. Note that coordinate transformation may be executed without using marks, such as by using the viewpoint position and capture direction of the overview camera 300.

Coordinate transformation can be executed in accordance with Equation 1 below, using a homography transformation matrix H.

$$( \begin{matrix}X \\ Y \\ W\end{matrix} ) = H ( \begin{matrix}x \\ y \\ 1\end{matrix} ) \qquad Equation 1$$

In Equation 1, x and y on the right side are horizontal and vertical coordinates in the overview camera coordinate system, and X and Y on the left side are horizontal and vertical coordinates in the planar coordinate system.

The homography transformation matrix can be calculated by substituting the coordinates of four marks detected from the video and the coordinates (known) of the four marks disposed in the capture range 20 into Equation 1 and solving the simultaneous equation. In the case where the positional relationship between the capture range 20 and the overview camera 300 is fixed, the homography transformation matrix H can be calculated in advance during test capture and saved to the ROM 103, for example.

The CPU 101 sequentially reads out the position of the object area from the RAM 102 and executes coordinate transformation to a value in the planar coordinate system. FIG. 7B schematically shows a state in which coordinate transformation of the feet coordinates (x, y) of each object area detected in video acquired from the overview camera 300 shown in FIG. 7A to coordinates (X, Y) of the planar coordinate system has been executed using Equation 1 and the homography transformation matrix H saved to the ROM 103. The CPU 101 stores the feet coordinates after coordinate transformation in the RAM 102 as POSITION[n].

(3) Next, an operation for specifying identification information ID[n] of an object with the object detection unit 104 will be described. Herein, objects are identified using template matching. Identification of objects is implemented on the processing results of the second iteration of object detection onward. Regarding the initial processing result, identification information ID[n] need only be newly assigned to the object area.

The object detection unit 104 specifies the identification information ID[n] of a detected object area, by template matching that uses templates stored in the RAM 102. An object within the capture range is thereby identified. The object detection unit 104 calculates an evaluation value representing the correlation of the individual templates, for every detected object area, for example. The object detection unit 104 then specifies, as the identification information ID[n] of the object area, identification information ID[n] corresponding to a template that has at least a certain correlation and has the highest correlation. A known value, such as the sum of the absolute differences of pixel values, can be used for the evaluation value.

Note that the object detection unit 104 assigns new identification information ID[n] to an object area that does not have at least a certain correlation with any of the templates and adds an image of the object area to a template.

Also, the object detection unit 104 may update an existing template using object areas detected in the most recent frame image and may delete a template with respect to which there has been no object area having at least a certain correlation for a certain period. Furthermore, the object detection unit 104 may store a template that corresponds to frequently appearing identification information ID[n] in the ROM 103.

Note that objects may be identified by methods other than template matching. For example, an object area closest to at least one of the previous detection position and size may be specified with the same identification information ID[n]. Also, a Kalman filter or the like may be used to predict a position in the current frame image from the transition of positions in a plurality of past detection results associated with the same identification information, and an object area closest to the predicted position may be specified with the same identification information ID. Also, these methods may be combined. By not using template matching, the accuracy of identifying different objects that look similar can be enhanced.

(4) The object detection unit 104 stores the specified identification information ID[n] and the position (planar coordinate system) POSITION[n] of the corresponding object area in the RAM 102 in association with each other.

Note that, apart from object detection, the CPU 101 may execute the processing of (1) to (4) instead of the object detection unit 104.

Herein, video from the overview camera 300 is used to derive the identification information ID[n] and the position POSITION[n] of objects within the capture range 20. However, video from the camera 400 may be used. If there are a plurality of cameras 400, the CPU 101 replaces the overview camera 300 with the cameras 400 and executes the operations shown in the flowchart of FIG. 4A for every camera. The position of the object area is output with a value in the coordinate system of every camera 400. In this way, while the overview camera 300 is not essential, object detection accuracy is considered to be better when the overview camera 300 is used.

In step S204, the CPU 101 serving as information acquisition means acquires the output of the generative AI model 107. Note that since the output timing of the generative AI model 107 is indeterminate, the output of the generative AI model 107 may be temporarily stored in the RAM 102 and then acquired from the RAM 102 at the timing of step S204.

In step S205, the CPU 101 serving as the role determination unit 121 determines the role (contents of automatic control) to be assigned to the camera 400, using the output of the generative AI model 107. The role determination operation will be described in detail later. Note that if there are a plurality of cameras 400, the CPU 101 executes the processing of steps S205 to S207 for every camera.

In step S206, the CPU 101 serving as a tracking object determination unit 123 determines an object to be tracked and captured by the camera 400, in accordance with the role CAMERA ROLE determined by the role determination unit 121. The CPU 101 determines the main object to be described in the role CAMERA ROLE assigned to the camera 400 as a tracking object of the camera 400.

The tracking object determination unit 123 sets the identification information ID[n] corresponding to the area of the object determined as the tracking object, among the object areas detected in step S203, as identification information SUBJECT ID of the tracking object of the camera 400.

The tracking object determination unit 123 stores the identification information SUBJECT_ID of the determined tracking object in the RAM 102. In the case where the tracking object can differ depending on the camera 400, the tracking object determination unit 123 stores the identification information SUBJECT_ID of the tracking object in the RAM 102 in association with the identification information of the camera 400. Note that, if the tracking object of the same camera changes, the tracking object determination unit 123 does not erase the information of previous tracking objects and holds this information in the RAM 102, in order to utilize the history of the tracking objects.

Returning to FIG. 4A, in step S207, the CPU 101 serving as a pan-tilt value calculation unit 124 calculates the amounts of change in the pan and tilt angles required for the camera 400 to track and capture images of the tracking object determined in step S206. Hereinafter, the case where there is one camera 400 will be described, but in the case of a plurality of cameras 400, the amounts of change in the pan and tilt angles and the zoom value are calculated for every camera.

First, the operations of CPU 101 serving as the pan-tilt value calculation unit 124 will be described. As mentioned above, the following information is stored in advance in the ROM 103 for every camera 400.
3D coordinates of the viewpoint position
Capture direction corresponding to the initial values of the pan and tilt angles of the drive unit 409
Controllable range of the pan and tilt angles

The CPU 101 converts the 3D coordinates of the viewpoint position of the camera 400 into coordinate values (subx, suby) of the planar coordinate system described above. Also, the CPU 101 reads out the feet coordinates (px, py) of the object area corresponding to the identification information SUBJECT_ID of the tracking object of the camera 400 from the RAM 102. The CPU 101 then first determines the pan angle from the feet coordinates and the viewpoint position of the camera 400.

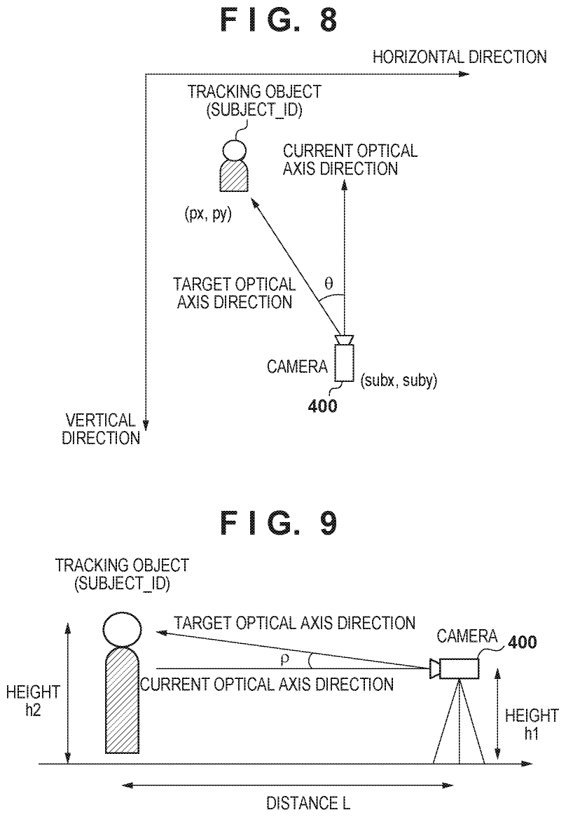

FIG. 8 shows an example of the positional relationship between the camera 400 and the tracking object in the planar coordinate system. Herein, a pan angle θ for orienting the optical axis direction of the camera 400 toward the object position is determined. Note that the target optical axis direction of the camera 400 can be different from the direction of the tracking object, according to the control contents of the composition described in the role set for the camera 400. The CPU 101 calculates the pan angle θ using Equation 2 below.

$$θ = {tan}^{- 1} \frac{px - subx}{py - suby} ( rad ) \qquad Equation 2$$

Herein, the current pan angle is initially 0 degrees, and the optical axis direction is vertical (Y-axis direction). If the current optical axis direction is not vertical, the angle difference between the current optical axis direction and the vertical direction need only be reflected in the angle obtained with Equation 2. Also, the pan direction is counterclockwise if subx>px, and clockwise if subx<px.

Next, the method of determining the tilt angle will be described using FIG. 9. FIG. 9 shows the camera 400 and the tracking object as viewed laterally. The current optical axis direction of the camera 400 is assumed to be horizontal and the height of the optical axis is given as h1. In the case of orienting the optical axis toward a face (height h2) of the tracking object, a tilt angle ρ for changing from the current optical axis direction to a target optical axis direction is derived. The CPU 101 calculates the tilt angle ρ using Equations 3 and 4 below.

L=\sqrt{(px−subx)²+(py−suby)²} Equation 3

$$ρ = {tan}^{- 1} \frac{h 2 - h 1}{∠} ( rad ) \qquad Equation 4$$

The coordinate values used in Equation 4 are the same as the coordinate values used in Equation 2. It is assumed that h1 and h2 have been input into the image capture control application in advance and are stored in the RAM 102. In this case, the identification number associated with h2 of every object and the identification number assigned by the object detection processing will be equal. h2 may be a value estimated from video acquired from the overview camera 300 or may be a value measured in real time using a sensor that is not shown.

Herein, the tilt angle is 0 degrees (default value) in the case where the current optical axis direction is horizontal. If the optical axis direction is not horizontal, the angular difference between the current optical axis direction and the horizontal direction need only be reflected in the tilt angle ρ obtained with Equation 4. Also, the direction of tilt is downward if h1>h2, and upward if h1<h2.

The CPU 101 communicates with the camera 400 through the communication network 700 on a periodical basis, and acquires the current optical axis direction (pan and tilt angles of drive unit 409) and stores the acquired optical axis direction in the RAM 102. Note that the communication period can be set to less than or equal to the reciprocal of the frame rate, for example. Alternatively, the total value of the pan and tilt angles of the camera 400 that are controlled by the CPU 101 from the initial state can be held in the RAM 102 and may be used as the current optical axis direction.

The CPU 101 calculates the amounts of change in the pan and tilt angles of the camera 400 and stores the calculated amounts of change in the RAM 102. Note that, if there are a plurality of cameras 400, the CPU 101 calculates the amounts of change in the pan and tilt angles for every camera.

The amounts of change in the pan and tilt angles may be used as angular velocities for the camera 400 to rotate in the direction of the tracking object. For example, the CPU 101 acquires the current pan and tilt angles from the camera 400 through the communication network 700. The CPU 101 then derives the angular velocity of pan proportional to the difference between the pan angle θ read out from the RAM 102 and the current pan angle. Also, the CPU 101 derives the angular velocity of tilt proportional to the difference between the tilt angle ρ read out from the RAM 102 and the current tilt angle. The angular velocities calculated in this way are stored in the RAM 102 by the CPU 101.

Note that the amounts of change in the pan and tilt angles may be calculated using video from the camera 400 instead of video from the overview camera 300. In this case, the CPU 101 calculates the amount of change in the pan angle from the horizontal difference between the current optical axis direction and the tracking object direction in the coordinate system of the camera 400, and the amount of change in the tilt angle from the vertical difference therebetween. Also, an image capture system that changes the capture direction for tracking and capturing images of the tracking object in only one of the pan direction and the tilt direction may be adopted, and such an image capture system may be configured to calculate only the amount of change in the one of the pan angle and the tilt angle.

Next, the operations of the CPU 101 serving as a zoom value calculation unit 125 will be described. The CPU 101 serving as the zoom value calculation unit 125 calculates a zoom value for the camera 400, in accordance with the control contents of the composition described in the role CAMERA ROLE set for the camera 400. For example, if the size of the object area of the tracking object is designated as the control content of the composition, the CPU 101 compares the current size with the designated size. If the sizes differ by greater than or equal to a threshold, a zoom value for reducing the difference is calculated. The zoom value calculated herein may be the amount of change from a zoom value corresponding to the current angle of view. The CPU 101 stores the calculated zoom value in the RAM 102.

In step S207, the CPU 101 reads out the amounts of change in the pan and tilt angles and the amount of change in the zoom value (i.e., PTZ values) calculated in step S206 from the RAM 102. The CPU 101 then generates a control command PT_VALUE for instructing the camera 400 to change the pan and tilt angles by amounts corresponding to these amounts of change. Also, the CPU 101 generates a control command Z_VALUE for instructing the camera 400 to change the angle of view by an amount corresponding to the amount of change in the zoom value. The format of the control command is assumed to be determined in advance. The CPU 101 stores the generated control commands PT_VALUE and Z_VALUE in the RAM 102. Note that if there is no need to generate control commands, such as when the tracking object is stationary, step S207 may be skipped.

The CPU 101 then reads out the control commands PT_VALUE and Z_VALUE from the RAM 102 and transmits the read out control commands to the communication network 700 through the network I/F 105. The camera 400 receives the control commands PT_VALUE and Z_VALUE through the network I/F 405.

The CPU 101 repeats execution of the processing from step S203 on the next frame image of video from the overview camera 300. Note that the processing of steps S203 to S207 need not necessarily be executed for every frame of video acquired from the overview camera 300.

### Operation of Role Determination Unit 121

The role determination operation that is executed in step S205 of FIG. 4A will be described in detail with reference to the flowchart shown in FIG. 5. The role determination operation is implemented by the CPU 101 executing the image capture control application and functioning as the role determination unit 121 in FIG. 3.

The role determination operation is executed when information is first acquired from the generative AI model 107 in step S204, and is thereafter executed when the acquired information changes. The role determination operation is also executed in the case where settings of a role for the camera 400 are changed through the user input unit 106.

In step S501, the CPU 101 serving as the role determination unit 121 determines the role to be assigned to each of the cameras 400, based on information acquired from the generative AI model 107. The CPU 101 then stores identification information of the camera and identification information of the assigned role in the RAM 102 in association with each other. In the above-mentioned Examples 1 to 3, the information output by the generative AI model 107 differs, and thus the operation for determining the role will be described in detail for each case.

In the case of Example 1, the generative AI model 107 discriminates the scene that is captured by the overview camera 300 and outputs the type of scene that was discriminated. If candidates for the type of scene are provided in a prompt, the generative AI model 107 outputs one of the candidates as a discrimination result.

In the case implementing Example 1, information (scene-specific role setting information) in which the role to be assigned to each camera is set is stored in advance in the ROM 103 for every type of scene. In step S501, the CPU 101 acquires, from the ROM 103, scene-specific role setting information corresponding to the information (type of scene) acquired from the generative AI model 107. The CPU 101 then determines the role to be assigned to each of the cameras 400 in accordance with the scene-specific role setting information.

If no candidates for scene type are described in the prompt, the discrimination result output by the generative AI model 107 can be a type of scene for which scene-specific role setting information is not provided. Thus, the CPU 101 determines whether the discrimination result by the generative AI model 107 is a type of scene for which scene-specific role setting information is provided. If it is determined that the discrimination result by the generative AI model 107 is that the scene type is a type for which scene-specific role setting information is provided, the CPU 101 determines the role to be assigned to each of the cameras 400 in accordance with the scene-specific role setting information. On the other hand, if it is determined that the discrimination result by the generative AI model 107 is that the scene type is a type for which scene-specific role setting information is not provided, the CPU 101 does not change the role to be assigned to each of the cameras 400.

In the case of implementing Example 2, information relating to the role of every camera 400 is obtained from the generative AI model 107. Since the generative AI model 107 selects a role from the candidates provided in a prompt, roles that cannot be assigned to the camera 400 will not be selected. Thus, in step S501, the CPU 101 is able to determine the role to be assigned to each of the cameras 400 as per information obtained from the generative AI model 107.

In the case of implementing Example 3, information relating to the role of every camera 400 is obtained from the generative AI model 107, similarly to Example 2. However, in the case of Example 3, the generative AI model 107 determines the combination of control items constituting the role, and thus a role that cannot be implemented by the camera 400 can be determined. Thus, in step S501, the CPU 101 determines whether the role determined for each of the cameras 400 by the generative AI model 107 can be implemented by the cameras 400. With regard to cameras 400 that are determined to be capable of implementing the role determined by the generative AI model 107, the CPU 101 employs the role determined by the generative AI model 107. On the other hand, with regard to cameras 400 that are determined to be incapable of implementing the role determined by the generative AI model 107, the CPU 101 does not change the role.

In step S502, the CPU 101 serving as the role determination unit 121 transmits the role CAMERA ROLE determined for every camera 400 to the tracking object determination unit 123. In practice, the CPU 101 stores the role CAMERA ROLE in a specific area of the RAM 102 and refers to the stored role when functioning as the tracking object determination unit 123.

In step S503, the CPU 101 serving as the role determination unit 121 transmits the role CAMERA ROLE determined for every camera 400 to the zoom value calculation unit 125. In practice, the CPU 101 stores the role CAMERA ROLE in a specific area of the RAM 102 and refers to the stored roles when functioning as the zoom value calculation unit 125.

### Operation of Overview Camera 300

Next, an operation of the overview camera 300 will be described with reference to FIG. 4B. The operation described below is realized by the CPU 301 executing a program.

When the overview camera 300 is powered on, the CPU 301 initializes the functional blocks and the overview camera 300 thereafter enters a capture standby state. In the capture standby state, the CPU 301 may start moving image capture processing for live view display, and output image data for display generated by the image processing unit 306 to the image capture control apparatus 100 through the network I/F 305.

In the capture standby state, the CPU 301 waits for receipt of a control command through the network I/F 305. Upon receiving a control command, the CPU 301 executes an operation that corresponds to the control command. Herein, an operation in the case where a capture command is received as a control command from the image capture control apparatus 100 will be described.

In step S301, the CPU 301 receives a capture command from the image capture control apparatus 100 through the network I/F 305.

Note that capture parameters such as frame rate and resolution may be designated in the capture command. Also, setting values relating to processing to be applied by the image processing unit 306 may also be included.

In step S302, the CPU 301 starts moving image capture processing for supplying moving image data to the image capture control apparatus 100 in response to receipt of the capture command. This moving image capture processing captures moving images of higher quality than the moving image capture processing for live view display. For example, at least one of the resolution and capture frame rate of the moving image is higher than the moving image for live view display. The image processing unit 306 applies processing to images, based on settings for moving images supplied to the image capture control apparatus 100. The image processing unit 306 stores the generated moving image data sequentially in the RAM 302.

In step S303, the CPU 101 reads out moving image data from the RAM 302 and transmits the read out moving image data to the image capture control apparatus 100 through the network I/F 305. Subsequently, the CPU 401 continues processing from capture to supply of moving image data until a control command to stop image capture is received.

### Operation of Camera 400

Next, an operation of the camera 400 will be described with reference to FIG. 4C. The operation described below is realized by the CPU 401 executing a program.

When the camera 400 is powered on, the CPU 401 initializes the functional blocks and starts moving image capture processing for supplying moving image data to the image capture control apparatus 100. The image processing unit 406 applies processing to an analog image signal obtained from the imaging sensor 407, based on settings for moving images to be supplied to the image capture control apparatus 100. The image processing unit 406 sequentially stores the generated moving image data in the RAM 402. The CPU 401 reads out the moving image data from the RAM 402 and supplies the read out moving image data to the image capture control apparatus 100 through the network I/F 405.

The CPU 401 supplies moving image data to the image capture control apparatus 100 while waiting for receipt of a control command through the network I/F 305. Upon receiving a control command, the CPU 401 executes an operation that corresponds to the control command. Herein, an operation in the case where a pan-tilt control command PT VALUE and a zoom control command Z VALUE are received from the image capture control apparatus 100 will be described.

In step S401, the CPU 401 receives at least one of the pan-tilt control command PT VALUE and the zoom control command Z VALUE from the image capture control apparatus 100 through the network I/F 405. The CPU 401 stores the received control commands in the RAM 402.

In step S402, the CPU 401 reads out an operating direction and a corresponding operating amount from the control commands stored in the RAM 402 and stores the read out operating direction and amount in the RAM 402. Herein, in the case of the pan-tilt control command PT_VALUE, the operating direction is the pan direction and/or tilt direction, and the operating amount is a target angle. Also, in the case of the zoom control command Z_VALUE, the operating amount is the zoom value and the operating direction can be specified from the zoom value, and thus there is no need to read out and store the operating direction.

In step S403, CPU 401 generates a drive parameter for the drive unit 409, based on the operating direction and operating amount read out in step S402. The CPU 401 may acquire a drive parameter that corresponds to the combination of the operating direction and operating amount, for example, using a table held in the ROM 403 in advance. Note that if the operating amount is given with a target value (target angle or zoom value), the CPU 401 acquires the drive parameter from the difference between the target value and the current value.

In step S404, the CPU 401 controls the drive unit 409 through the drive I/F 408, based on the drive parameter acquired in step S403. The drive unit 409 thereby changes the capture direction of the camera 400 to the operating direction and angle designated by the pan-tilt control command PT_VALUE. Also, the drive unit 409 changes the angle of view of the image capture optical system to the zoom value designated in the zoom control command Z_VALUE.

According to the present embodiment, in an image capture control apparatus that realizes flexible automatic control by preparing a pattern of automatic control as a role and assigning a role for every camera, the roles to be assigned to the cameras are automatically determined based on information obtained using a generative AI model. For example, by providing video captured by the overview camera to a generative AI model and causing the generative AI model to perform scene discrimination, role determination, role generation, and the like, determination and changing of roles can be automated and labor savings can be realized.

### Second Embodiment

Next, a second embodiment will be described. In the second embodiment, one of a plurality of cameras 400 is a main camera and the remaining cameras are sub-cameras, and the operations of the sub-cameras are controlled with consideration for the main object and zoom operation of the main camera, in addition to the roles assigned to the sub-cameras. The capture direction and angle of view of the main camera may be manually operated by a user of the image capture control apparatus or may be automatically controlled in accordance with a role assigned in advance.

In the present embodiment, a role that includes control contents based on the main object and zoom operation of a main camera 4001 can be assigned to a sub-camera 4002. For example, in relation to the control item “main object”, control contents set to the same object as or a different object to the main object of the main camera 4001 can be designated. Also, in relation to the control item “angle of view”, control contents for executing zoom operation in the same phase as or the opposite phase to zoom operation of the main camera 4001 can be designated. Herein, “same phase” indicates that the zoom directions (telescopic directions or wide-angle directions) are the same, that is, that changes in the angle of view occur in the same direction. On the other hand, “opposite phase” indicates that the zoom directions (telescopic directions or wide-angle directions) are opposite, that is, changes in the angle of view occur in opposite directions. Also, in relation to the control item “angle of view”, control contents indicating that the zoom value is the same (angle of view is the same) as the main camera 4001 can also be designated.

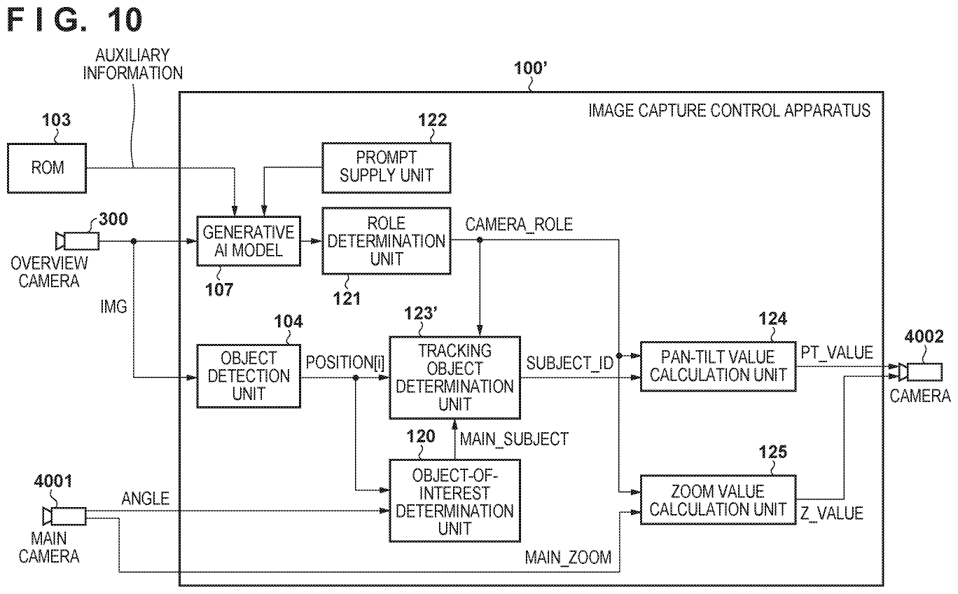

FIG. 10 is a diagram showing a series of processing that is implemented by an image capture control apparatus 100′ when controlling the operations of the sub-camera at the time of implementing Example 1 of the first embodiment in the present embodiment, similarly to FIG. 3. Herein, the camera 4001 is the main camera and the camera 4002 is the sub-camera.

An object-of-interest determination unit 120, which is a function realized by the CPU 101, is added to the image capture control apparatus 100′. The object-of-interest determination unit 120 detects an object-of-interest of the main camera 4001.

The CPU 101 serving as the object-of-interest determination unit 120 acquires information ANGLE indicating the capture direction from the main camera 4001 on a regular basis. Specifically, the CPU 101 transmits a capture direction acquisition command to the main camera 4001 through the network I/F 105 on a regular basis using a predetermined protocol. The CPU 401 of the main camera 4001 transmits information ANGLE indicating the current capture direction of the main camera 4001 to the image capture control apparatus 100, every time the capture direction acquisition command is received. The information ANGLE may be the pan and tilt angles of the drive unit 409, for example. The CPU 101 stores the acquired information ANGLE in the RAM 102.

The CPU 101 serving as the object-of-interest determination unit 120 determines the object-of-interest of the main camera 4001. The CPU 101 is able to determine the object-of-interest of the main camera 4001 from the object area detected in step S203, based on the capture direction of the main camera 4001. The CPU 101 transmits identification information ID[n] corresponding to the object area determined as the object-of-interest of the main camera 4001 to a tracking object determination unit 123′ as the identification information MAIN_SUBJECT of the object-of-interest. In practice, the CPU 101 stores the identification information MAIN_SUBJECT of the object-of-interest in a specific area of the RAM 102 and refers to this identification information when functioning as the tracking object determination unit 123′.

For example, the CPU 101 is able to determine an object closest to the capture direction of the main camera 4001 in a planar coordinate system as the object-of-interest of the main camera 4001. Note that if there are a plurality of objects whose distance from the capture direction of the main camera 4001 is less than or equal to a threshold, the user may be allowed to select an object-of-interest from among these objects.

In the case where the user is allowed to select the object-of-interest, the CPU 101 displays a frame image to which object detection processing was applied in step S203 on the display unit 108 or an external display device, together with an indicator indicating the capture direction and an indicator indicating object areas serving as candidates for the object-of-interest. The indicator of the object area may be a rectangular frame indicating the outer edge of the object area such as is shown in FIG. 7A, for example, but may be other indicators. Also, the CPU 101 may display a message or the like prompting selection of an object-of-interest within the image on the display unit 108.

The user is able to operate the user input unit 106 (input device) to select an object area corresponding to a desired object-of-interest. The selection method is not particularly restricted, and may be an operation that involves operating a mouse or a keyboard to designate a desired object area.

Upon detecting a user operation designating an object area, the CPU 101 stores the identification information ID[n] corresponding to the designated object area in the RAM 102 as the identification information MAIN_SUBJECT of the object-of-interest.

In the present embodiment, the tracking object determination unit 123′ determines the tracking object of the sub-camera 4002 in step S206, with consideration for the identification information MAIN_SUBJECT of the main camera 4001, in addition to the role CAMERA ROLE. Specifically, the tracking object determination unit 123′ examines the control contents of the control item “main object” of the role determined by the role determination unit 121 for the sub-camera 4002, when determining the tracking object of the sub-camera 4002. The tracking object determination unit 123′ then determines the tracking object with consideration for the identification information MAIN SUBJECT, if the control item “main object” describes control contents based on the object-of-interest of the main camera 4001.

Also, in step S207, the CPU 101 serving as the zoom value calculation unit 125 determines whether the control item “angle of view” of the role CAMERA ROLE that corresponds to the role set for the sub-camera 4002 describes control contents based on zoom operation of the main camera 4001. If it is determined that such control contents are described, the information MAIN_ZOOM indicating the angle of view of the main camera 4001 is acquired on a periodical basis and stored in the RAM 102. If the information MAIN_ZOOM changes, the CPU 101 generates a control command Z VALUE for zoom in order to change the angle of view of the sub-camera 4002 in accordance with the control contents.

Note that the CPU 101 is able to determine zoom operation of the main camera 4001 and the phase thereof by detecting change in the angle of view of video from the main camera 4001, for example. The CPU 101 may, for example, detect change in the angle of view from change in the size or interval of the object area over time.

Note that control contents based on zoom operation of the main camera 4001 in the control item “angle of view” of the role and control contents relating to the size of the main object in the control item “composition” are assumed to be exclusive.

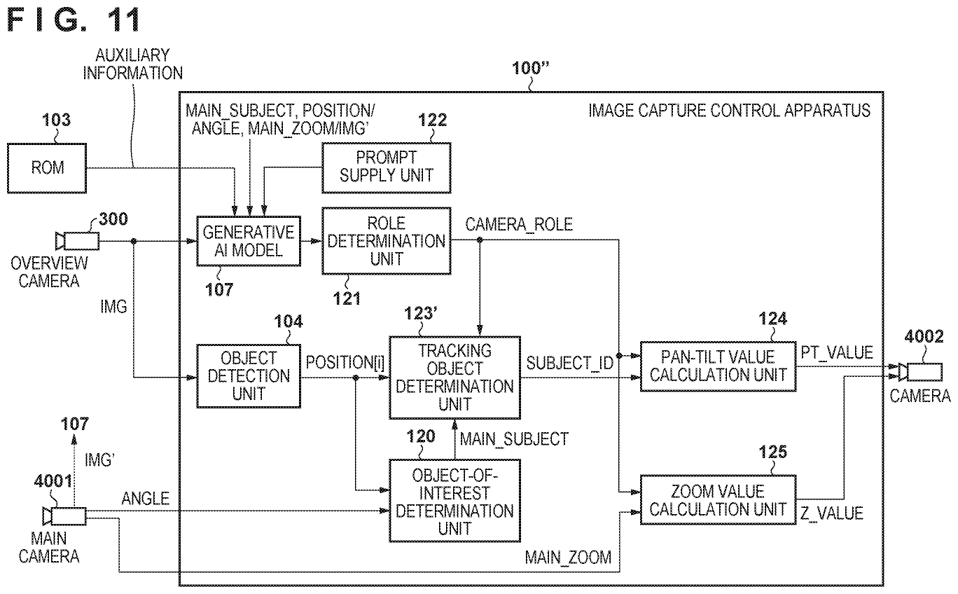

FIG. 11 is a diagram showing a series of processing that is implemented when controlling operations of the sub-camera with an image capture control apparatus 100″ at the time of implementing Example 2 or 3 of the first embodiment in the present embodiment, similarly to FIG. 10. The following description focuses on the differences with the case of implementing Example 1. In the case of implementing Example 2 or 3, the generative AI model 107 needs to consider information of the main camera 4001 in selecting or generating roles. Specifically, the CPU 101 inputs information relating to one or more of the capture direction, the main object, and the angle of view into the generative AI model 107 as information of the main camera 4001.

Information in the capture direction of the main camera 4001 may be the information ANGLE. Information of the main object of the main camera 4001 may be a combination of MAIN SUBJECT and POSITION corresponding thereto.

Information of the angle of view of the main camera 4001 may be MAIN_ZOOM. Note that captured video IMG′ may be supplied to the generative AI model 107 as information of the main camera 4001. The angle of view of the main camera 4001 and change thereof can be detected from the video IMG′ from the main camera 4001. Information relating to the capture direction and the main object can also be detected, by taking the video IMG from the overview camera 300 into consideration.

In the case of implementing Example 2, a prompt generated by the prompt supply unit 122 is:
Preconditions
   information (file format, etc.; if video from the main camera 4001 is also input, video from the overview camera 300 is described separately to video from the main camera 4001) of video data targeted for processing
   information of viewpoint position, capture direction, and angle of view of the overview camera 300
   information (name or identification information, coordinate values of installation position (viewpoint position) and coordinate values of origin) of the main camera 4001
   description of type and contents of information to be provided to the AI model in relation to one or more of capture direction, main object, and angle of view of the main camera 4001
   information (name or identification information, coordinate values of installation position (viewpoint position) and coordinate values of origin, reference capture direction, controllable range of pan and tilt angles relative to the reference capture direction, controllable range of zoom (angle of view), etc.) of each of the cameras 400 assigned a role
   information (name or identification information, control item, control contents) of each of candidates for roles assignable to the cameras 400
Processing Contents
   standpoint of video producer
   in the case of recognizing a capture scene from video data and capturing multi-angle video with a plurality of cameras in order to produce video of the recognized scene, selection of suitable role from among the candidates as automatic capture control of the individual cameras
   in selecting candidates, information in relation to one or more of capture direction, main object, and angle of view of the main camera to be provided may be taken into consideration
   conditions for reselection (e.g., every certain time period if the capture scene changes; etc.)
Output format
   designation of data structure and file type
   output conditions (e.g., output when the selection result changes; output every time selection is performed; etc.); etc.

These may be described with a natural language document.

Also, the prompt in the case of Example 3 may be a prompt in which the contents described in the processing contents of the prompt in the case of Example 2 are changed as follows.
Processing Contents
   standpoint of video producer
   in the case of recognizing a capture scene from video data and capturing multi-angle video with a plurality of cameras in order to produce video of the recognized scene, generation of suitable role by combining one or more control items and control content candidates as automatic capture control of the individual cameras
   in selecting candidates, information in relation to one or more of capture direction, main object, and angle of view of the main camera to be provided may be taken into consideration
   conditions for reselection (e.g., every certain time period if the capture scene changes; etc.)

In the case of definitely wanting to select roles with consideration for information of the main camera 4001, consideration need only be described as essential in the processing contents. The operations of the role determination unit 121 and the operations that correspond to the determined role are similar to the case of Example 1.

According to the present embodiment, automatic control of sub-cameras that takes the main object and zoom operation of the main camera into consideration also becomes possible, in addition to similar effects to the first embodiment.

### Other Embodiments

Embodiment(s) of the present disclosure can also be realized by a computer of a system or apparatus that reads out and executes computer executable instructions (e.g., one or more programs) recorded on a storage medium (which can/may also be referred to more fully as a ‘non-transitory computer-readable storage medium’) to execute/perform the functions of one or more of the above-described embodiment(s) and/or that includes one or more circuits (e.g., application specific integrated circuit (ASIC)) for executing/performing the functions of one or more of the above-described embodiment(s), and by a method executed/performed by the computer of the system or apparatus by, for example, reading out and executing the computer executable instructions from the storage medium to execute/perform the functions of one or more of the above-described embodiment(s) and/or controlling the one or more circuits to execute/perform the functions of one or more of the above-described embodiment(s). The computer can/may comprise one or more processors (e.g., central processing unit (CPU), micro processing unit (MPU)) and can/can/may include a network of separate computers or separate processors to read out and execute the computer executable instructions. The computer executable instructions can/may be provided to the computer, for example, from a network or the storage medium. The storage medium can/can/may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-069084, filed Apr. 18, 2025, which is hereby incorporated by reference herein in its entirety.

What is claimed is:

1. An image capture control apparatus, comprising one or more processors that execute a program stored in a memory and thereby cause the image capture control apparatus to:
acquire first video capturing an entirety of a predetermined capture range;
provide the first video and text information to a generative AI model, the text information describing a content of processing to be executed based on the first video, information to be output as a result of the processing, a method of outputting the information, and a precondition of the processing, and acquire, from the generative AI model, information that is based on the text information;
determine a role for each of one or more remotely controllable image capture apparatuses, based on the information acquired from the generative AI model; and
control one or both of a capture direction and an angle of view of each of the one or more image capture apparatuses, in accordance with the determined role.

2. The image capture control apparatus according to claim 1,
wherein the one or more processors cause the image capture control apparatus to:
provide the text information which includes description of capture scene candidates to the generative AI model, and acquire, from the generative AI model, a discrimination result of a capture scene selected from the capture scene candidates; and
control, one or both of the capture direction and the angle of view of each of the one or more image capture apparatuses, in accordance with a role determined in advance for each of the one or more image capture apparatuses for one of the capture scene candidates indicated by the capture scene discrimination result, among the roles determined in advance for each of the one or more image capture apparatuses for each of the capture scene candidates.

3. The image capture control apparatus according to claim 2,
wherein the one or more image capture apparatuses include one first image capture apparatus and one or more second image capture apparatuses, and
the roles include a role for controlling one or both of the capture direction and the angle of view of the one or more second image capture apparatuses according to a main object and zoom operation of the first image capture apparatus.

4. The image capture control apparatus according to claim 1,
wherein the one or more processors cause the image capture control apparatus to:
provide the text information which includes description of role candidates to the generative AI model, and acquire, from the generative AI model, one role selected from the role candidates for each of the one or more image capture apparatuses; and
control, for each of the one or more image capture apparatuses, one or both of the capture direction and the angle of view in accordance with the one role selected by the generative AI model.

5. The image capture control apparatus according to claim 4,
wherein the text information which includes description of a capture scene of the first video is provided to the generative AI model.

6. The image capture control apparatus according to claim 4,
wherein the one or more image capture apparatuses include one first image capture apparatus and one or more second image capture apparatuses, and
the role candidates include a role for controlling one or both of the capture direction and the angle of view of the one or more second image capture apparatuses according to a main object and zoom operation of the first image capture apparatus.

7. The image capture control apparatus according to claim 6,
wherein the one or more processors cause the image capture control apparatus to:
further provide information of the first image capture apparatus to the generative AI model.

8. The image capture control apparatus according to claim 7,
wherein the information of the first image capture apparatus includes information relating to a position of the first image capture apparatus and one or more of information relating to the capture direction, the main object, and the angle of view of the first image capture apparatus.

9. The image capture control apparatus according to claim 1,
wherein the one or more processors cause the image capture control apparatus to:
provide the text information which includes description of combinations of a control item and a control content that may constitute the role to the generative AI model, and acquire, from the generative AI model, a role constituted by one or more of the combinations for each of the one or more image capture apparatuses; and
control, for each of the one or more image capture apparatuses, one or both of the capture direction and the angle of view in accordance with the role acquired from the generative AI model.

10. The image capture control apparatus according to claim 9,
wherein any of the acquired roles that is determined to be unimplementable is not used in control of the one or more image capture apparatuses.

11. The image capture control apparatus according to claim 9,
wherein the one or more image capture apparatuses include one first image capture apparatus and one or more second image capture apparatuses, and
the control content includes a control content for controlling one or both of the capture direction and the angle of view of the one or more second image capture apparatuses according to a main object and zoom operation of the first image capture apparatus.

12. The image capture control apparatus according to claim 11,
wherein the one or more processors cause the image capture control apparatus to:
further provide information of the first image capture apparatus to the generative AI model.

13. The image capture control apparatus according to claim 12,
wherein the information of the first image capture apparatus includes information relating to a position of the first image capture apparatus and one or more of information relating to the capture direction, the main object, and the angle of view of the first image capture apparatus.

14. The image capture control apparatus according to claim 1,
wherein the text information includes a position, a capture direction, and a controllable range of the angle of view of the one or more image capture apparatuses, and a position, a capture direction, and an angle of view of the image capture apparatus that captures the first video.

15. An image capture system comprising:
one or more image capture apparatuses; and
the image capture control apparatus according to claim 1.

16. An image capture control method comprising:
acquiring first video capturing an entirety of a predetermined capture range;
providing the first video and text information to a generative AI model, the information describing content of processing to be executed based on the first video, information to be output as a result of the processing, a method of outputting the information, and a precondition of the processing, and acquiring, from the generative AI model, information that is based on the text information;
determining a role for each of one or more remotely controllable image capture apparatuses, based on the information acquired from the generative AI model; and
controlling one or both of a capture direction and an angle of view of each of the one or more image capture apparatuses, in accordance with the determined role.

17. A non-transitory computer-readable medium storing a program that causes a computer to execute an image capture control method comprising:
acquiring first video capturing an entirety of a predetermined capture range;
providing the first video and text information to a generative AI model, the information describing content of processing to be executed based on the first video, information to be output as a result of the processing, a method of outputting the information, and a precondition of the processing, and acquiring, from the generative AI model, information that is based on the text information;
determining a role for each of one or more remotely controllable image capture apparatuses, based on the information acquired from the generative AI model; and
controlling one or both of a capture direction and an angle of view of each of the one or more image capture apparatuses, in accordance with the determined role.
